(19) United States
(12) Patent Application Publication
(10) Pub. No.: US 2010/0029462 A1
(43) Pub. Date: Feb. 4, 2010

(54) Ceramic precursor having improved manufacturability

(76) Inventors: Michael Edward DeRosa, Painted Post, NY (US); Thomas Mark Dubots, Elmira, NY (US); Michelle Yumiko Ronco, Horseheads, NY (US); Gary Graham Squier, Elmira, NY (US)

Correspondence Address: CORNING INCORPORATED, SP-TI-3-1, CORNING, NY, 14831, US

(21) Appl. No.: 12/221,374

(22) Filed: Aug. 1, 2008

(51) Int. Cl. C04B 38/10

(52) U.S. Cl. 501/80

(57) ABSTRACT

A batch mixture including ceramic forming ingredients; a pore former mixture of a graphite and a starch; a hydroxypropyl methyl cellulose binder; and a liquid vehicle, as defined herein. Also disclosed is a method for producing a ceramic precursor article having enhanced throughputs in extrusion and drying as defined herein.

The entire disclosure of any publication, patent, or patent document mentioned herein is incorporated by reference.

### FIELD

The disclosure is generally directed to ceramic-forming batch mixtures with pore former and to ceramic-forming green bodies with pore former, and methods for making ceramic bodies.

### BACKGROUND

Exhaust gases emitted by internal combustion systems utilizing hydrocarbon fuels, such as hydrocarbon gases, gasoline, or diesel fuel, can cause serious pollution of the atmosphere. Among the many pollutants in these exhaust gases are hydrocarbons and oxygen-containing compounds, the latter including nitrogen oxides (NOₓ) and carbon monoxide (CO). The automotive industry has, for many years, attempted to reduce the quantities of pollutants from automobile engine systems, the first automobiles equipped with catalytic converters having been introduced in the mid 1970's. Cordierite substrates, typically in the form of a honeycomb body, have long been preferred for use as substrates to support catalytically-active components for catalytic converters on automobiles.

Aluminum titanate (AT) ceramics have emerged as an excellent candidate for high-temperature applications. To achieve the desired porosity in such aluminum titanate materials, graphite pore formers have been added to the inorganic batch materials. However, the addition of graphite may undesirably result in very long firing cycles, for example, in excess of 180 hours, to achieve burnout of the graphite without causing part cracking. Furthermore, high levels of graphite are not desired because of the adverse effect on dielectric drying, a conventional approach for drying green bodies formed of inorganic materials.

Hydrophobically modified cellulose polymers such as methylcellulose (MC) and hydroxypropyl methylcellulose (HPMC) have been used as binders in automotive substrate and diesel filter ceramic precursor batch compositions. These polymers give the batch the necessary plasticity and green strength in the forming and drying stages to produce high quality honeycomb ware. However, polymers such as MC and HPMC can undergo phase separation and subsequent gelation at a characteristic temperature. At such a temperature the methyl cellulosic polymers lose the water that surrounds the pendant methoxy side groups. This loss of hydration exposes the methoxy groups and enables hydrophobic associations to occur between the methoxy substituents of neighboring chains. This leads to phase separation and ultimately the build up of a long range network gel. (references 1-5). When the binder undergoes this thermal phase transition within a ceramic precursor batch, the batch becomes stiffer and the extrusion pressure increases significantly which can produce severe defects in the extruded honeycomb structure. The thermal transition behavior of polymers like MC and HPMC can limit the extrusion process of numerous ceramic product lines. The batch temperature increases with feed rate due to increased shear heating in the extruder. Ultimately, throughput reaches a limit as the batch approaches the thermal transition temperature of the binder.

### SUMMARY

The disclosure relates to a composition having superior onset-of-gelation temperature or batch stiffening temperature and superior throughput properties in the manufacture of batch mixtures and green bodies for ceramic articles, such as aluminum titanate containing honeycomb ceramic articles. In embodiments, the disclosure provides batch mixtures and batch processes for making a ceramic article. The disclosed batch mixtures can provide, for example, enhanced feed-rates in extrusion and enhanced feed-rates in green ware drying.

### BRIEF DESCRIPTION OF THE DRAWING(S)

FIG. 1 shows the relationship of gelation onset temperature difference (ΔTₒₙₛₑₜ) with extrusion pressure at a constant material stiffness or viscosity of compositions and a comparative composition, in embodiments of the disclosure.

FIGS. 2A and 2B show the relationship of an extruded log's temperature and length with varied ratios of graphite to starch pore former after electromagnetic drying using microwave drying only (FIG. 2A), and the combination of microwave and radiofrequency drying (FIG. 2B), in embodiments of the disclosure.

FIG. 3 shows the relationship of electromagnetic half power penetration depth and half depth ratio at 915 MHz of the measured dielectric properties of AT compositions having varied amounts of the graphite pore former component, in embodiments of the disclosure.

FIG. 4 shows the loss tangent and the loss tangent ratio of the dry to the wet batch for AT compositions and an improvement over cordierite with graphite levels less than about 8% super addition, in embodiments of the disclosure.

### DETAILED DESCRIPTION

Various embodiments of the disclosure will be described in detail with reference to drawings, if any. Reference to various embodiments does not limit the scope of the invention, which is limited only by the scope of the claims attached hereto. Additionally, any examples set forth in this specification are not limiting and merely set forth some of the many possible embodiments for the claimed invention.

### Definitions

“Gelation temperature” refers to the temperature at which a batch has stiffened to such an extent that it cannot effectively be extruded.

“Tₒₙₛₑₜ” refers to the temperature at which the rheology of the batch begins to transition from low to high viscosity.

“Include,” “includes,” or like terms refer to “including but not limited to,” i.e., inclusive rather than exclusive.

“About” modifying, for example, the quantity of an ingredient in a composition, concentrations, volumes, process temperature, process time, yields, flow rates, pressures, film thickness, and like values, and ranges thereof, employed in describing the embodiments of the disclosure, refers to variation in the numerical quantity that can occur, for example: through typical measuring and handling procedures used for making compounds, compositions, concentrates or use formulations; through inadvertent error in these procedures; through differences in the manufacture, source, or purity of starting materials or ingredients used to carry out the methods; and like considerations. The term “about” also encompasses amounts that differ due to aging, for example, of a composition or formulation with a particular initial concentration or mixture, and amounts that differ due to mixing or processing a composition or formulation with a particular initial concentration or mixture. Whether modified by the term “about” or not the claims appended hereto include equivalents to these quantities.

“Consisting essentially of” in embodiments refers, for example, to a batch mixture, green body, or ceramic article manufactured as defined herein; and a method for making or using the batch mixture, green body, or ceramic article as defined herein, and can include the components or steps listed in the claim, plus other components or steps that do not materially affect the basic and novel properties of any of the compositions, articles, apparatus, and methods of making and use of the disclosure, such as particular reactants, particular materials, particular additives or ingredients, particular agents, particular surface modifier or surface conditions, or like structure, material, or process variable selected. Items that may materially affect the basic properties of the components or steps of the disclosure or may impart undesirable characteristics to the present disclosure include, for example, high graphite pore former content, reduced throughput volume or increased throughput time in extrusion or in drying operations, and like characteristics.

Thus, the claimed invention may suitably comprise, consist of, or consist essentially of, for example, a batch mixture, green body, or ceramic article manufactured as defined herein; and a method for making or using the batch mixture, green body, or ceramic article as defined herein.

The indefinite article “a” or “an” and its corresponding definite article “the” as used herein means at least one, or one or more, unless specified otherwise.

Abbreviations, which are well known to one of ordinary skill in the art, may be used (e.g., “h” or “hr” for hour or hours, “g” or “gm” for gram(s), “mL” for milliliters, and “rt” for room temperature, “nm” for nanometers, and like abbreviations).

Specific and preferred values disclosed for components, ingredients, additives, reactants, and like aspects, and ranges thereof, are for illustration only; they do not exclude other defined values or other values within defined ranges. The compositions, apparatus, and methods of the disclosure include those having any value or any combination of the values, specific values, more specific values, and preferred values described herein.

In embodiments, the disclosure provides a ceramic precursor batch composition, comprising:

inorganic ceramic-forming ingredients;

a pore former consisting essentially of a mixture of a graphite and a starch, the mixture having a graphite to the starch weight ratio of from about 1:1 to about 3:5;

an organic binder consisting essentially of a hydroxypropyl methyl cellulose having hydroxypropyl substitution of from about 8 to about 15 wt % and methoxyl substitution of from about 20 to about 26 wt % based on the total weight of the hydroxypropyl methyl cellulose;

a fatty acid oil; and

a liquid vehicle.

In embodiments, the inorganic ceramic-forming ingredients can comprise, for example, from about 35 to about 75% by weight of the total batch material;

the pore former consists essentially of from about 13 to about 20% by weight of the inorganic batch material, by super-addition;

the hydroxypropyl methyl cellulose consists essentially of from about 3 to about 5% by weight of the combined inorganic and pore former batch materials, by super-addition;

the fatty acid oil comprises from about 0.2 to about 2% by weight of the combined inorganic and pore former batch material, by super-addition; and

the liquid vehicle to balance, based on the total weight of the batch mixture prior to extrusion.

In embodiments, the disclosure provides an aluminum titanate ceramic forming batch mixture, the mixture including, for example:

inorganic batch materials comprised of sources of alumina, titania, and silica;

a pore former consisting of a graphite and a starch in a weight ratio of, for example, from about 1:1 to 3:5;

an organic binder consisting of a hydroxypropyl methyl cellulose having hydroxypropyl substitution of from about 8 to about 15 wt % and methoxyl substitution of from about 20 to about 26 wt % based on the total weight of the hydroxypropyl methyl cellulose; and

a liquid vehicle.

In embodiments, the batch mixture can include, for example:

sources of alumina, titania, and silica in an amount of from about 35 to about 75 wt %;

the pore former in an amount from about 13 to about 20% by weight of the inorganic batch material by super-addition;

the hydroxypropyl methyl cellulose in an amount from about 3 to about 5% by weight of the combined inorganic and pore former batch material by super-addition; and

the liquid vehicle to balance, such as in an amount from about 25 to about 65 wt %, based on the total weight of the batch mixture prior to extrusion.

In embodiments, the disclosure provides an aluminum titanate ceramic forming green body, the body comprising:

a homogeneous mixture of inorganic batch materials including sources of alumina, titania, and silica;

a pore former in an amount of from about 13 to about 20% by weight of the inorganic batch by super-addition, consisting essentially of or consisting of graphite and starch, wherein the weight ratio of graphite to starch is from about 1:1 to 3:5; and

an organic binder comprising a hydroxypropyl methyl cellulose having a hydroxypropyl substitution of from about 8 to about 15 wt %.

The green body can include a plurality of interconnected cell walls forming a plurality of cell channels traversing the body.

In embodiments, the batch composition liquid vehicle can be, for example, water, water miscible liquids such as alcohol, acetone, and like solvents, or combinations thereof to dissolve or disperse the binder with the other ingredients of the batch. A 2% (w:v) solution of the binder in water can have a viscosity at 20° C., for example, of about 30,000 to about 50,000 centipoise (cP), about 35,000 cP to about 45,000 cP, and about 38,000 cP to about 42,000 cP, including intermediate ranges and values. The ceramic forming materials can be, for example, sources of alumina, titania, and silica, and the hydroxypropyl methyl cellulose binder can have a molecular weight, for example, of from about 25,000 to about 300,000, including intermediate ranges and values.

The fatty acid oil can be, for example, tall oil (tallol), tall oil fatty acid, oleic acid, tallow fatty acids, and like oils and surface active (surfactant) components, or mixtures thereof, in an amount of from about 0.2 to about 2%, 0.5 to about 1.5%, and from about 1 to about 1.5% by weight, including intermediate ranges and values, of the combined inorganic and pore former batch materials, by super-addition.

In embodiments, the ceramic composition can further comprise cordierite, mullite, clay, talc, zircon, zirconia, spinel, aluminas and their precursors, silicas and their precursors, silicates, aluminates, lithium aluminosilicates, alumina silica, feldspar, titania, fused silica, nitrides, carbides, borides, silicon carbide, silicon nitride, soda lime, aluminosilicate, borosilicate, soda barium borosilicate, and like ingredients, or mixtures of thereof.

In embodiments, the disclosure provides a method for enhancing feed rates in extruding and drying in the manufacture of a ceramic precursor green body, the method comprising:

mixing inorganic ceramic-forming ingredients with a pore former consisting essentially of graphite and starch, the weight ratio of graphite to starch can be, for example, from about 1:1 to about 3:5, including intermediate ranges and values, to form a batch;

adding an organic binder consisting essentially of a hydroxypropyl methyl cellulose having a hydroxypropyl substitution of from about 8 to about 15 wt %, including intermediate ranges and values, and a liquid vehicle or solvent to the batch and further mixing to form a plasticized mixture; and

extruding and drying the plasticized mixture to form a green body.

The extruded and dried green body can be fired to produce a honeycomb ceramic, such as an aluminum titanate.

In embodiments, the disclosure provides a method for enhancing throughput of one or more process steps, such as increased feed rates in extruding and drying in the manufacture of a ceramic precursor green body, the method including:

mixing inorganic ceramic-forming ingredients with a pore former consisting essentially of graphite and starch, the weight ratio of graphite to starch can be, for example, from about 1:1 to about 3:5, to form a batch;

adding an organic binder consisting essentially of a hydroxypropyl methyl cellulose having a hydroxypropyl substitution of from about 8 to about 15 wt % and a liquid vehicle to the batch and further mixing to form a plasticized mixture; and

extruding and drying the plasticized mixture to form the green body.

In embodiments, the disclosure provides a method wherein extruding the plasticized mixture provides an extrudate log having a temperature profile (ΔT) across the log length of less than about 20° C. during drying as measured, for example, by forward looking infrared (FLIR), or like equipment and methods. The extruding can be accomplished, for example, at an increased feed rate of from about 25 to about 40% compared to a batch having a pore former consisting essentially of a graphite to starch ratio of 5:4 or greater, and a hydroxypropyl methyl cellulose binder with hydroxypropyl substitution of about 4 to about 7.5% and methoxyl substitution of about 27 to about 30 wt % based on the total weight of the hydroxypropyl methyl cellulose. The drying can be accomplished at an increased feed rate of from about 25 to about 40% compared to a batch having a pore former consisting essentially of a graphite to starch ratio of 5:4 or greater, and a hydroxypropyl methyl cellulose binder with hydroxypropyl substitution of about 4 to about 7.5% and methoxyl substitution of about 27 to about 30 wt % based on the total weight of the hydroxypropyl methyl cellulose.

In embodiments, the disclosure provides a method for controlling the gelation onset temperature during extrusion of a honeycomb green body batch, the method comprising:

mixing inorganic ceramic-forming ingredients with a pore former consisting essentially of graphite and starch, the weight ratio of graphite to starch is from about 1:1 to about 3:5, to form a batch;

adding an organic binder consisting essentially of a hydroxypropyl methyl cellulose having a hydroxypropyl substitution of from about 8 to about 15 wt % and a liquid vehicle to the batch and further mixing to form a plasticized mixture; and

extruding the plasticized mixture to form the green body, the extruded mixture having a gelation onset temperature difference (Δ Tₒₙₛₑₜ) of from about 5° C. to about 15° C., including intermediate ranges and values, at a constant material stiffness or viscosity compared to a batch having a pore former consisting essentially of a graphite to starch ratio of 5:4 and a hydroxypropyl methyl cellulose binder with hydroxypropyl substitution of about 4 to about 7.5% and methoxyl substitution of about 27 to about 30 wt % based on the total weight of the hydroxypropyl methyl cellulose.

In embodiments, the batch materials can comprise sources of alumina, titania, and silica. In embodiments, the manufacture method can further comprise firing the green body to produce a predominant ceramic phase, for example, aluminum titanate.

In embodiments, the disclosure provides products that include the fired articles and methods of using the articles of the disclosure. In embodiments, the firing can produce, for example, a ceramic article having a material composition, expressed in weight % on an oxide basis, comprising 40-65% Al₂O₃, 25-40% TiO₂, and 3-12% SiO₂.

The batch mixtures and processes of the present disclosure are superior to related mixtures and processes that employ similar components but differ in the amounts of components selected and the relative weight ratio of the components selected. The superiority of the batch mixtures and processes of the present disclosure obtains from superior throughput, i.e., feed rates in extrusion and from superior feed rates in drying. Although not bound by theory, the increased feed rate in extrusion is believed to be enabled by an increase in gelation temperature of the batch mixture and the increased feed rate in drying is believed to result from the reduction in the temperature differential (ΔT) between the center-to-end of the extruded log to a differential of about 20° C., or alternatively, end-to-end of the extruded log to a differential of about 20° C.

In embodiments, the batch mixtures can provide a superior feed rate of from about 25 to about 40% in extrusion and a superior feed rate from about 25 to about 40% in drying compared to, for example, a batch having a pore former of a graphite to starch ratio of 5:4 and a hydroxypropyl methyl cellulose binder with hydroxypropyl substitution of about 4 to about 7.5% and methoxyl substitution of about 27 to about 30 wt % based on the total weight of the hydroxypropyl methyl cellulose.

Copending U.S. Provisional Application No. 60/686,117, filed May 31, 2005, entitled “Aluminum Titanate Ceramic Forming Batch Mixtures and Green Bodies Including Pore Former Combinations and Methods of Manufacturing and Firing Same,” now U.S. Patent Publication 20070006561 (U.S. Ser. No. 11/445,024), discloses, for example, a ceramic forming batch mixture including inorganic batch materials, such as sources of alumina, titania, and silica, a pore former combination including first and second pore formers with different compositions; an organic binder; and a solvent. Also disclosed is a method for producing a ceramic article involving mixing the inorganic batch materials with the pore former combination having first and second pore formers of different composition, adding an organic binder and a solvent, and forming a green body; and firing the green body.

Copending U.S. Provisional Application No. 60/932,476, filed May 31, 2007, entitled “Aluminum Titanate Ceramic Forming Batch Mixtures and Green Bodies with Pore Formers,” discloses, for example, a ceramic forming batch mixture including inorganic batch materials, such as sources of alumina, titania, and silica, a low amount of one or more pore formers including at least one starch; an organic binder; and a solvent.

Copending U.S. Provisional Application No. 61/004996, filed Nov. 30, 2007, entitled “Ceramic Precursor Batch Composition and Method of Increasing Ceramic Precursor Batch Extrusion Rate,” discloses, for example, a ceramic precursor batch composition comprising inorganic ceramic-forming ingredients, a hydrophobically modified cellulose ether binder having a molecular weight less than or equal to about 300,000 g/mole and an aqueous solvent. The ceramic precursor batch composition has a ratio of binder to aqueous solvent of less than about 0.32. The ceramic precursor batch composition can be used to increase the rate of extrusion of the composition. A method for increasing a rate of extrusion of a ceramic precursor batch composition is also disclosed.

U.S. Pat. No. 3,919,384, to Cantaloupe, et al., assigned to Corning Glass Works, entitled “Method for Extruding Thin-Walled Honeycombed Structures,” mentions extrusion of mixtures of particulate-blends, water, and methyl cellulose having a gel point.

In embodiment, the present disclosure provides batch mixtures that can contain aluminum titanate ceramic forming compositions with a combination or mixture of particulate pore formers. The pore former can be, for example, two or more pore former agents, such as graphite and starch, in a specified amount and in a specified ratio. The pore former can be, for example, a batch addition which provides or assists in the formation of interconnected pores (voids) in the resultant ceramic article upon completion of the firing cycle. The pore former preferably burns-out, i.e., decomposes or oxidizes, and preferably is converted to a gas, such as CO or CO₂, and leaves behind the desired void or porosity, which is preferably open-interconnected porosity, within, for example, the final aluminum titanate ceramic article as the article being fired. “Burn-out” of the pore former occurs, preferably, before the formation of the principal ceramic phase, such as a phase of aluminum titanate. Although not bound by theory, the use of two or more different pore forming agents is believed to space out the exothermic reactions associated with burn-out, such that the overall temperature peaks are lowered as compared to a single pore forming agent, for example, using graphite alone.

In embodiments, the disclosed ceramic article can be a ceramic honeycomb body comprised of a plurality of intersecting cell walls. In embodiments, the ceramic article is a substrate, which can be coated with a catalyst, such as a catalyzed flow-through substrate. In embodiments, a plurality of the cells of the honeycomb body of the ceramic article can be plugged, for example, to form a wall-flow filter. A ceramic article containing, for example an aluminum titanate phase can be a honeycomb body having of a plurality of intersecting cell walls. In embodiments, this article can be configured as a particulate filter and can include an inlet end, which is exposed in use to an incoming exhaust stream, and an outlet end opposed thereto, through which the filtered exhaust gases exit. This article can include a plurality of inlet channels extending and traversing along the length of the filter, and a plurality of exit channels also extending and traversing along the length of the filter alongside the inlet channels. In embodiments, the shape of the channels can be generally square and they may include small radii or bevels on the corners thereof. Alternatively or additionally, the channels (e.g. the cross-sectional shape of the channel in a transverse plane perpendicular to the longitudinal axis of article) can have other shapes. Other channel shapes can be, for example, rectangular, triangular, octagon, hexagon, circular, and like shapes, or combinations thereof. The cross-sectional area of each of the inlet and outlet channels can be different. For example, the average inlet area of inlet channels may be larger than the average outlet area of the outlet channels. Intersecting cell walls can be formed by, for example, extruding the disclosed batch mixture composition through an extrusion die to form an extruded green body. Although extrusion is one preferred forming method, the forming step may include any known method for forming green bodies.

Plugs can be made from suitable ceramic material and extend radially across and between the intersecting walls to close off (i.e., seal) an end of each of the channels. Plugs can be formed, for example by the methods of U.S. Pat. No. 4,557,773. Any suitable plugging technique can be used. Further, partial channels (e.g., channels which do not share a common shape with the majority of channels on a transverse plane of the article, such as at or near the outer periphery of the honeycomb body) adjacent to the skin can be plugged on both ends to add strength, if desired. The article described above can be a particulate wall-flow filter. The disclosed batch mixture, firing, and manufacture methods can also be useful for non-filter applications, for example, as catalyzed flow-through substrates.

In embodiments of the disclosure, the total amount (wt %) and relative ratio (w:w or weight ratio) of pore formers selected can promote more rapid burn-out of the pore formers within the aluminum titanate forming green body, compared to batch mixtures having higher wt % and weight ratio of pore formers. Batch formulation mixtures having combinations of reduced levels of pore former can provide levels of porosity greater than, for example, about 40%, and can also provide shorter drying and firing cycles for aluminum titanate articles. In embodiments, the aluminum-titanate-forming compositions of the disclosure can include pore former combinations that can reduce the overall propensity of the resultant ceramic parts to crack upon firing. In embodiments, the porosity of the fired ceramic article can be less than about 50%, which can result in stronger ceramic (e.g., honeycomb) bodies (e.g., substrates or filters). In embodiments, the porosity of the fired ceramic article can be, for example, greater than about 40% and less than about 55%.

The pore formers of the disclosed batch mixtures can include a pore former mixture of a graphite and a starch, where the pore former mix can be present in about 13 to about 20% by weight of the inorganic batch materials by super-addition. The pore former mixture can include other pore forming agents in addition to graphite and starch which do not substantially effect the improved extrusion and drying properties of disclosed compositions. The starch can include one starch or more than one starch. The starch can be selected from various starch types or sources, for example, from corn, barley, bean, potato, rice, tapioca, pea, sago palm, wheat, canna, and like starches, or combinations thereof. In embodiments, the starch can be about 6% to about 10%, by weight, of the inorganic batch materials. In embodiments, the starch can be about 7% to about 10 wt % of the inorganic batch materials. In embodiments, the starch can be about 8% to about 9 wt % of the inorganic batch materials. In embodiments, the graphite can be, for example, in one or more of the following forms: crystalline such as flakes; amorphous such as fine particles; or lump, and like forms, or a combination thereof. In embodiments, the pore former includes essentially no thermoplastic polymer or thermoset polymer.

In embodiments, the inorganic batch materials can contain about 10 wt % to about 20 wt % of the pore former mixture, including intermediate values and ranges. In embodiments, the inorganic batch materials can contain about 12 wt % to about 18 wt % of the pore former prior to firing.

In embodiments, the pore former consists of a mixture of graphite and starch. In embodiments, the graphite can be present in from about 5 to about 10 wt % based on the weight of the inorganic batch materials, by super-addition. In embodiments, the graphite can be present in from about 6 to about 8 wt % of the inorganic batch materials, by super-addition. In embodiments, the starch can be present in an amount of from about 5 to about 12 wt % of the inorganic batch materials by super-addition, and the graphite can be present in an amount of from about 5 to about 10 wt % of the inorganic batch materials, by super-addition. In embodiments, the starch can be, for example, less than about 10 wt % of the inorganic batch materials by super-addition, and the graphite can be, for example, less than about 8 wt % of the inorganic batch materials, by super-addition. In embodiments, the batch mixture includes the starch in no less than 8 and no more than 10 wt % of the inorganic batch materials by super-addition, and the graphite in no less than about 5 and no more than about 8 wt % based on the total weight of the inorganic batch materials, by super-addition.

In embodiments, the aluminum titanate ceramic forming green body can include, for example: a homogeneous mixture of inorganic batch materials including sources of alumina, titania, and silica; a pore former mixture of starch and graphite, the pore former mixture can be, for example, less than about 15 wt % of the inorganic batch materials; and an organic binder. The extruded green body can include a plurality of interconnected cell walls forming a plurality of cell channels traversing the body.

In embodiments, the disclosure provides a method of making an aluminum titanate containing ceramic article, the method comprising, for example: mixing inorganic batch materials with a pore former to form a batch composition, wherein the pore former is of from about 13 to about 20% by weight of the inorganic batch material by super-addition; adding an organic binder and a liquid vehicle, such as an aqueous solvent, to the batch composition and further mixing to form a plasticized mixture; forming a green body from the plasticized mixture by, for example, extrusion and drying; and firing the green body to produce a ceramic body having a predominant phase of aluminum titanate. In embodiments, the ceramic body has a porosity of greater than about 40%. In embodiments, the porosity can be greater than about 40% and less than about 50%. In embodiments, the porosity can be less than about 50%.

It has been found that using a lower amount of pore former in the ceramic precursor batch mixture, such as for aluminum titanate honeycomb manufacture, the mixture upon being formed into a green body and fired results in a sintered ceramic article, characterized by a primary crystalline phase of aluminum titanate, and which also exhibits desirable physical properties. In particular, the ceramic article so produced can have a porosity of greater than about 40%, and in embodiments greater than about 45% and less than about 50%, as measured by mercury porosimetry. In embodiments, Median Pore Size (MPS) of the article can be less than about 15 microns, and from about 8 to about 15 microns. In embodiments, the (d₅₀−d₁₀)/d₅₀ is less than about 0.7, and in embodiments from about 0.2 to about 0.7. The compositions, articles, and methods of the disclosure are particularly useful for producing honeycomb aluminum titanate ceramic articles, and more particularly for producing aluminum-titanate-containing ceramic particulate filters useful for filtering particulate matter from exhaust streams. The d₁₀, of a fired ceramic article is the pore diameter at which the cumulative mercury intrusion volume equals 10% of the total mercury intrusion volume. The median pore diameter (MPD), d₅₀, is the pore diameter at which the cumulative mercury intrusion volume equals 50% of the total mercury intrusion volume. One measure of the pore size distribution of a ceramic article is characterized by a d_{factor}, wherein d_{factor}=(d₅₀−d₁₀)/d₅₀.

A suitable source of alumina can be, for example, a powder which when heated to a sufficiently high temperature in the absence of other raw materials, will yield substantially pure aluminum oxide. Such suitable alumina sources include alpha-alumina, a transition alumina such as gamma-alumina or rho-alumina, hydrated alumina, gibbsite, corundum (Al₂O₃), boehmite (AlO(OH)), pseudoboehmite, aluminum hydroxide (Al(OH)₃), aluminum oxyhydroxide, or like materials, and mixtures thereof. The median particle diameter of the source of alumina is preferably below about 35 microns.

A suitable titania source can be, for example, rutile, anatase, or an amorphous titania. The median particle size of the titania source can be selected to avoid entrapment of unreacted oxide by the rapidly growing nuclei in the structure. A preferred median particle size can be, for example, less than about 20 micrometers.

Suitable silica sources can include, for example, non-crystalline silica such as fused silica or sol-gel silica, silicone resin, low-alumina substantially alkali-free zeolite, diatomaceous silica, kaolin, and crystalline silica, such as quartz or cristobalite. Additionally, the silica-forming source can comprise a compound that forms free silica, when heated, for example, silicic acid or a silicon organometallic compound. The median particle size of the silica source can be, for example, less than about 30 micrometers.

If strontium is optionally selected as an alkaline earth metal oxide, then a suitable strontium source can be, for example, strontium carbonate, having a median particle size of, for example, less than about 20 micrometers. If barium is selected, suitable barium sources can be, for example, barium carbonate, barium sulfate, or barium peroxide, having a median particle size of, for example, less than about 20 micrometers. If calcium is selected, the calcium source can be, for example, either calcium carbonate or calcium aluminate, having a median particle size of, for example, less than about 20 micrometers.

If a rare earth is selected, then a suitable source of rare earth oxide can be, for example, lanthanum oxide (La₂O₃), yttrium oxide (Y₂O₃), any oxide of the lanthanide series, or combinations thereof.

In embodiments, the abovementioned inorganic batch materials can be combined as powders in a mixing step sufficient to produce an intimate mixing. The pore formers, individually or in combination, can be added to this mix, either simultaneously or with the other batch components or after the inorganic materials are intimately mixed. The pore former can be intimately mixed with the inorganic batch materials to form, for example, a homogeneous powdered mixture of the inorganic materials and the pore formers.

An organic binder system can be added to the batch inorganic materials and the pore formers to create an extrudable mixture that is formable and moldable. A preferred multi-component organic binder system for use in embodiments of the disclosure includes a binder of a cellulose-containing component, an optional surfactant component, and a liquid vehicle. The binder system can include a base such as triethanol amine (TEA), added for example at about 0.1 to about 0.5 wt %, which base acts as a dispersant to help disperse the surfactant. The cellulose-containing component can be, for example, an organic cellulose ether binder component selected from one or more alkylated alkylcellulose derivatives, such as an hydroxyalkyl methylcellulose or a combination thereof. The surfactant component can be, for example, tall oil. The liquid vehicle, such a solvent for the binder and a carrier for the insoluble ingredients, can be, for example, water such as deionized water. Excellent results have been obtained with a cellulose-based binder system comprised of about 8 to about 15% hydroxypropyl substitution by weight based on total hydroxypropyl methyl cellulose weight, optionally from about 0.2 to about 2.0 parts by weight of tall oil, and about 10 to about 30 parts by weight of water as solvent or liquid dispersant to balance, based on 100 parts-by-weight of the inorganic materials.

The individual components of the binder system can be, for example, mixed with a mass of the inorganic powder materials and pore former mixture, in any suitable manner, to prepare an intimate homogeneous mixture of the inorganic powder material, pore formers, and binder system. This aluminum titanate forming batch mixture can be formed into a ceramic forming green body, for example, by extrusion. All components of the binder system can be mixed with each other in advance, and the mixture can then be added to the powdered inorganic material previously mixed with the pore formers. In this instance, the entire portion of the binder system can be added at once, or divided portions of the binder system can be added sequentially at suitable intervals. Alternatively, the components of binder system can be added sequentially to the ceramic batch materials, or each previously prepared mixture of two or more components of the binder system can be added to the ceramic powder material and pore former combination. For example, the dry components can be first added to the inorganic batch materials and pore former combination, followed by the liquid components. Further, the binder system can be first mixed with a portion of the ceramic forming powder material. In this instance, the remaining portion of the ceramic forming powder is subsequently added to the prepared mixture. In embodiments, the binder system can be uniformly mixed with the inorganic batch powders and pore formers in a predetermined portion to form a homogeneous batch mixture. Uniform mixing of the binder system, the ceramic inorganic materials, and the pore former can be accomplished by, for example, a kneading process.

The resulting stiff, uniform, homogeneous, and extrudable batch mixture can then be further plasticized and shaped or otherwise formed into a green body. Such shaping or forming can be accomplished, for example, by ceramic forming processes, such as extrusion, injection molding, slip casting, centrifugal casting, pressure casting, press molding, and like processes, or a combination thereof. For the preparation of a thin-walled honeycomb substrate suitable for use as a catalyst support or as a particulate filter, extrusion through a slotted extrusion die is suggested, see for example, U.S. Pat. No. 6,696,132, which discloses a “Honeycomb with Varying Size and Die for Manufacturing.”

The prepared aluminum titanate ceramic forming green body, such as an extruded log or like shape formed from the plasticized extrudable batch mixture can be dried before firing. Drying can be achieved by, for example, drying methods such as hot-air, electromagnetic energy drying (e.g., RF or microwave), vacuum drying, freeze drying, and like methods, or a combination thereof can be used. The dried green body can then be suitably fired by heating to a sufficient top temperature (the highest temperature of the cycle) for a sufficient time to result in a fired ceramic body. In embodiments, aluminum titanate is the primary crystal phase formed as a result of firing the green body made from the disclosed batch mixture described above.

The firing conditions can be varied depending on the process conditions, such as specific composition of the batch, size of the green body, and nature of the equipment, but preferably can include burning-out the pore formers to produce, for example, the aluminum titanate phase when using the batch mixtures described herein. In embodiments, the green body can be heated in a furnace to a top temperature such as in a range having an upper limit below about 1,550° C. and a lower limit of above about 1,350° C., and in embodiments below about 1,460° C. and above about 1,420° C. and held in this range for greater than about 4 hours, such as between about 4 and about 30 hours, and in embodiments, between about 6 to about 20 hours. During firing, a predominant ceramic crystal phase is formed in the ceramic article. The ceramic crystal phase can be aluminum titanate for the batch described above.

As mentioned above, a primary use of the batch mixtures described herein is for preparing high strength aluminum titanate containing honeycomb articles useful as catalyst carriers, diesel particulate filters (which may also include a catalyst), and like articles or devices.

In embodiments, the disclosure provides ceramic forming compositions having a reduced ratio of graphite to starch pore former and a hydroxypropyl modified methyl cellulose (HPMC) binder having increased hydroxypropyl substitution compared to known compositions. The batch mixtures can provide improved feed rates in extrusion and drying process steps, which in turn provide increased efficiency of manufacture, reduced energy consumption, reduced costs, higher quality, and like benefits. In embodiments, the disclosed batch mixtures can provide, for example, reduced raw material costs since, for example, less graphite is used.

In embodiments, the batch compositions of the disclosure can provide increased extrusion feed rates, for example, increased by from about 25 to about 40% compared to a comparable composition having a higher graphite to starch ratio. The batch compositions of the disclosure can impart or promote an elevated batch gelation temperature to the batch mixtures. The disclosed batch compositions can provide an overall reduction in total manufacture time of the ceramic precursors and the ceramic articles.

In embodiments, the disclosed batch mixtures can provide, for example, improved thermal uniformity of the extruded bodies during drying, such as a reduction of the temperature differential (ΔT) between the center-to-the-end of the extruded log.

In embodiments, the disclosed batch mixtures can provide an aluminum titanate (AT) composition prior to firing having, for example, from about 3 to about 5% by weight of a hydroxypropyl methylcellulose binder, as super-addition to the combined inorganic and pore former batch material, and a pore former combination of from about 6 to about 8% by weight of a graphite, and from about 8 to about 10% by weight of a starch, as super-additions to the inorganic batch.

In embodiments, the disclosure provides compositions having a specific hydroxypropyl methylcellulose (HPMC) binder combined with a reduced graphite to starch pore former ratio. The compositions can provide an increased extrusion feed rate in batch, semi-continuous, or continuous green body manufacture and increased drying rates or increased dryer feed rates in batch, semi-continuous, or continuous green body manufacture compared to compositions having a higher graphite to starch pore former ratio. The disclosed compositions retain desirable microstructure and physical property attributes of the AT compositions disclosed in, for example, the abovementioned U.S. Patent Publication 20070006561 (U.S. Ser. No. 11/445,024), such as having 50% and above porosity.

Certain AT compositions commercially available from Corning Inc., include manufacture from green ware having an F-type HPMC binder. Extrusion feed rates of these formulated composition can be limited due to a problematic lower gelation temperature for the AT batch, and even lower batch stiffening temperature, at which temperatures part-shape deformation can occur as a result of flow front changes from skin-to-core batch temperature differences. The higher-hydroxypropyl substituted binder of the disclosure undergoes phase separation and gelation at a higher temperature, which allows the batch to extrude to higher temperatures before shape deformation so that higher extrusion feed rates can be realized. This aspect however, is reduced or offset by the tendency of HPMC binders with high hydroxypropyl substitution to remain hydrated and thus more difficult to dry. To counteract this effect batch composition having reduced graphite to starch pore former ratios were investigated and found to improve the dielectric properties of the AT composition for microwave (MW) and radiofrequency (RF) penetration through the ware during drying. The improved radiation penetration afforded by the formulations consistently provided higher feed rates in the drying step.

METHOCEL®™ cellulose ether products are available from The Dow Chemical Company (www.dow.com/methocel) in two basic types: methylcellulose and HPMC (also known as hypromellose). METHOCEL®™ products have a polymeric backbone of cellulose, a natural carbohydrate that contains a basic repeating structure of anhydroglucose units. In hydroxypropyl methylcellulose products (such as METHOCEL® J and K brand products), propylene oxide is used in addition to methyl chloride to obtain hydroxypropyl substitution on the anhydroglucose units. This substituent group, —OCH₂CH(OH)—CH₃, contains a secondary hydroxyl on the number two carbon and can also be considered a propylene glycol ether of cellulose. These products possess varying ratios of hydroxypropyl and methyl substitution (methylated hydroxyls), which can influence, for example, the solubility in organics and the thermal gelation temperature of aqueous solutions. In METHOCEL® K products, the methoxyl substitution is still the major constituent, see Table 1. The molar substitution (MS) is the number of moles of hydroxypropyl groups per mole of anhydroglucose.

TABLE 1
Comparison of METHOCEL ® F and K Products.

| | Methoxyl | | Hydroxypropyl | |
|---|---|---|---|---|
| | Degree of | | Molar | Hydroxy- |
| METHOCEL ® | Substitution | Methoxyl | Substitution | propyl |
| Product Type | (DS) | % | (MS) | % |
| F | 1.8 | 28 | 0.13 | 5.0 |
| K | 1.4 | 22 | 0.21 | 8.1 |

A representative AT composition of the present disclosure is listed in Table 2. A related AT composition is disclosed in copending patent application U.S. Ser. No. 12/072791, filed Feb. 28, 2008, entitled “METHOD OF INCREASING CERAMIC PASTE STIFFENING/GELATION TEMPERATURE BY USING A SALT AND PRECURSOR BATCH.”

TABLE 2
Composition of aluminum titanate containing ceramic paste

| | | Weight |
|---|---|---|
| | Material | Percent |
| INORGANICS | Silica | 10.19 |
| | Strontium Carbonate | 8 |
| | Calcium Carbonate | 1.38 |
| | Alumina | 46.57 |
| | Titanium Dioxide | 29.95 |
| | Hydrated Alumina | 3.71 |
| | Lanthanum Oxide | 0.2 |
| Total | | 100 |
| PORE FORMERS | Potato Starch | 8 |
| | Graphite | 8 |
| Total | | 116 |
| BINDER(S) | Hydroxypropyl methylcellulose | 4 |
| Total | | 120 |
| OTHER LIQUID | Fatty Acid oil | 1 |
| ADDITIONS | Water (to balance) | |
| | Grand Total | 121 |

### EXAMPLES

The following examples serve to more fully describe the manner of using the above-described disclosure, and to set forth examples contemplated for carrying out various aspects of the disclosure. It is understood that these examples are presented for non-limiting demonstrative purposes.

### Example 1

Effect of HPMC binder on Tₒₙₛₑₜ An identical series of ceramic (AT) precursor batch mixtures were prepared with the exception of differences in water content and the selection of hydroxypropyl substituted F— and K-type HPMC binder for each mixture. The binders are commercially available from several sources (e.g., Dow, ShinEtsu, Hercules/Aqualon). The precursor batch mixtures were used to determine the role of the different binders on batch stiffening temperature, i.e., Tₒₙₛₑₜ of the batch. The Tₒₙₛₑₜ can be determined according to, for example, the abovementioned copending patent application U.S. Ser. No. 12/072791. The batch stiffening temperature (Tₒₙₛₑₜ) of the control and compositions of the disclosure were measured using a dual barrel temperature sweep method. Tₒₙₛₑₜ is the temperature at which the capillary pressure increases by 15% above the stable baseline pressure during extrusion through a zero length capillary die. At this temperature the binder begins to undergo its thermal phase transition and the pressure begins to increase sharply. The batch mixtures were mixed and extruded through a twin screw lab scale mixer. The batch stiffening temperature Tₒₙₛₑₜ was measured using a capillary rheometer temperature sweep technique on 13 mm diameter rod samples directly extruded from the twin screw mixer.

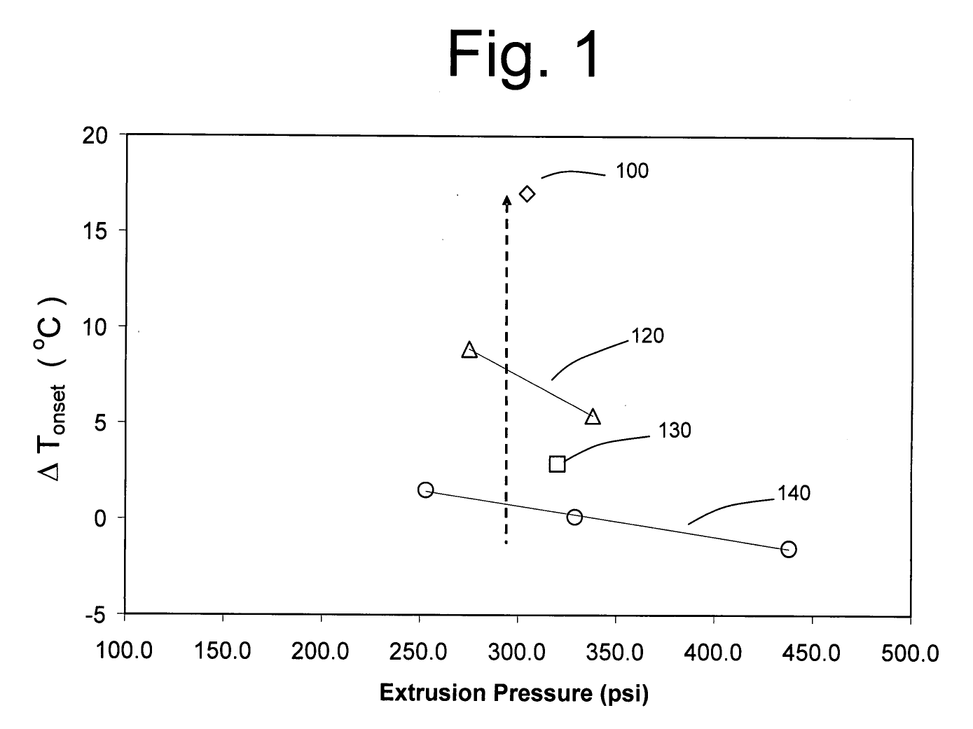

Higher extrusion feed rates, as measured by an increase in Tₒₙₛₑₜ, while maintaining extrudability performance (i.e., torque, batch stiffness, shape), was evident with the K-type HPMC binders. The K-type HPMC binders have higher hydroxypropyl substitution levels compared to the F-type HPMC binders, i.e., about 8-15 wt % for K-type versus about 4-7.5% for F-type. The hydroxypropyl substitution levels can also vary within a subset such that some K-type binders have a higher batch stiffening temperature than others, and allow for higher extrusion feed rates to be achieved. Since different binders can also change the Theological behavior of ceramic pastes in addition to changing their transition temperatures, the Tₒₙₛₑₜ of different compositions were compared at equivalent ambient material stiffness values. FIG. 1 shows the relationship of the increase of batch stiffening temperature (ΔTₒₙₛₑₜ) as a function of material stiffness of green ware formulations having different compositions of the disclosure and a comparative baseline formulation. Material stiffness is proportional to the extrusion pressure of the batch going through an orifice capillary die of 1 mm in diameter, 0.25 mm length, at an extrudate velocity of about 0.1 in/s at 23° C. In embodiments, the batch mixtures of the disclosure exhibit, for example, a Tₒₙₛₑₜ delta (ΔTₒₙₛₑₜ) of greater than about 5° C., or greater than about 10° C., or even greater than about 15° C., at a constant material stiffness at ambient temperature. FIG. 1 and Table 3 shows that the composition containing the binder with the highest level of hydroxypropyl substitution (HPMC#1) exhibited the greatest increase in Tₒₙₛₑₜ at a constant level of stiffness indicated by the vertical dashed arrow.

TABLE 3
ΔTₒₙₛₑₜ dependence on HPMC type

| HMPC | | | |
|---|---|---|---|
| (FIG. 1 reference | | Hydroxypropyl | Batch water |
| numeral) | ΔTₒₙₛₑₜ (° C.) | substitution % | wt % |
| Control Baseline | 0 | 4-7.5% | 14.8 |
| Reference | | | 15.5 |
| (140) | | | 16.2 |
| HPMC#1 | +17 | 11-15% | 15.5 |
| (100) | | | |
| HPMC#2 | +9 | 9-11% | 16.2 |
| (120) | | | 16.9 |
| HPMC#3 | +5 | 8% | 16.2 |
| (130) | | | |

### Example 2

Extrusion Scale-up Example 1 was repeated by formulating batches with the most favorable of the above mentioned K-type HPMC binders with the exception that the honeycomb wares were extruded with a larger scale twin screw extruder. The resulting honeycomb ware samples were compressed into blocks using a hydraulic press. 13 mm diameter rods were cored from these blocks and placed in the capillary rheometer for temperature ramp testing. The measured ΔTₒₙₛₑₜ results were comparable to those obtained above with the smaller extruder.

Additional experiments that were conducted on the larger scale twin screw extruder used HPMC#1, HPMC#2, and HPMC#1 blended with an F-type HPMC binder. The blend of F-type with the K-type HPMC#1 binder was aimed at achieving at least some of the extrusion feed rate benefit and to reduce the negative effect of the K-type binder when used alone on the drying properties (dryability) of the extruded ware. From these additional experiments, HPMC#1 was identified as an overall superior HPMC binder which provided both extrusion feed rate and drying feed rates enhancements for AT green ware manufacture. Extrusion feed rates, as calculated from the Tₒₙₛₑₜ response, were confirmed with feed rate experiments conducted on a manufacturing scale.

### Example 3

Improved Dielectric Properties for Improved Drying An identical series of ceramic (AT) batch precursors were prepared as in Example 1 with the exception that the super addition of the pore former was from about 15 to about 18 wt %, to provide a desired final porosity, such as greater than about 40% and less than about 55%. The graphite to starch pore former weight ratios of the super additions was also varied from about 5:4 to about 0:7.5. The varying level and ratio of pore former was used to determine the effect that the graphite had on the penetration depth of the electromagnetic energy used for drying and the relative change in dielectric properties of the honeycomb article between the wet batch and dry batch materials. The batches were prepared and extruded on a small extruder to simulate the mixing and shear history. The complex dielectric properties of the entire series were then measured, using a cavity perturbation technique (ref. 6), over frequencies of about 27 MHz to about 2,450 MHz.

To define a target drying property, a baseline composition of cordierite was compared with the drying properties (dryability) of the abovementioned AT series having varying levels of graphite. The purpose of the comparison was to identify a composition having improved drying performance over the cordierite reference. Cordierite can contain, for example, as much as 20 wt % super-addition of graphite as a pore former and filter article pieces can be, for example, 14 inches or more in diameter. Such composition and dimensional properties can create drying hurdles, such as the electromagnetic energy's inability to penetrate into large frontal area pieces without overheating and scorching the log's exterior, without leaving excess water in the piece's interior, or both. The dielectric properties of the disclosed AT compositions were intrinsically higher than cordierite making it more difficult to penetrate with even less graphite. Therefore, having AT compositions with dielectric properties that were more electrically transparent, that is less electrically conductive or having a lower complex permitivity, than comparable cordierite logs improved the log's dielectric uniformity and provided the drying enhancements desired for high volume throughput.

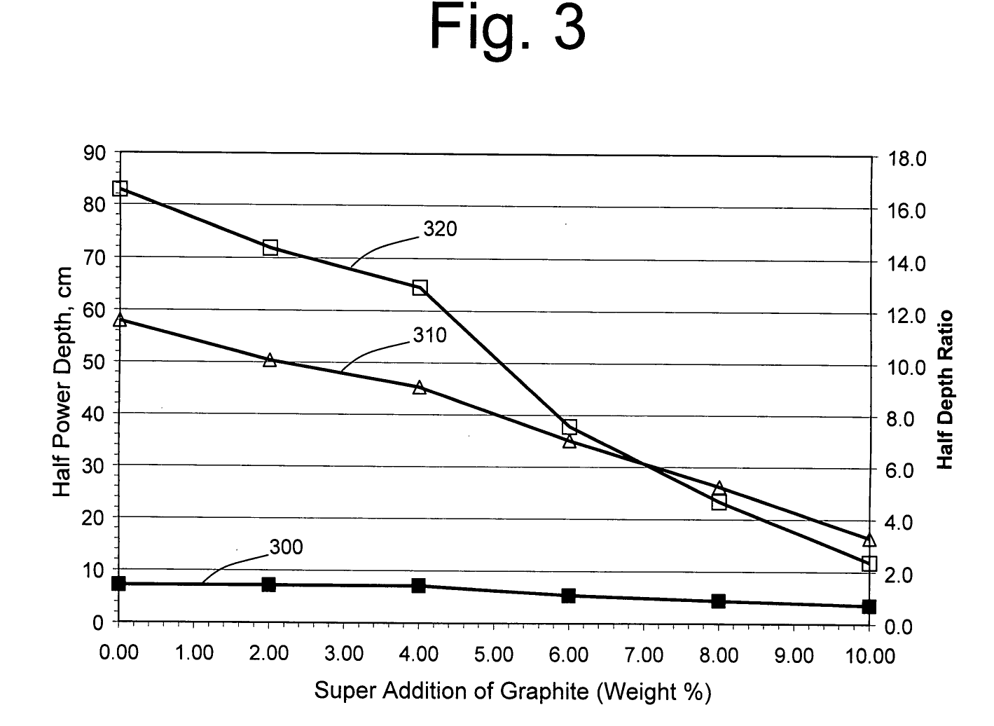

FIG. 3 shows that at the processing frequency of 915 MHz, the radiation penetration depth or half power depth of dry AT material needed to be greater than about two times the cross sectional radius of the log to completely penetrate to the core. About 5.7 times more power, that is half power distance in centimeters, is absorbed by the wet (300) material than the dry (320) material with 0 wt % graphite. At 10 wt % graphite, only 1.6 times the power goes into the wet than the dry material.

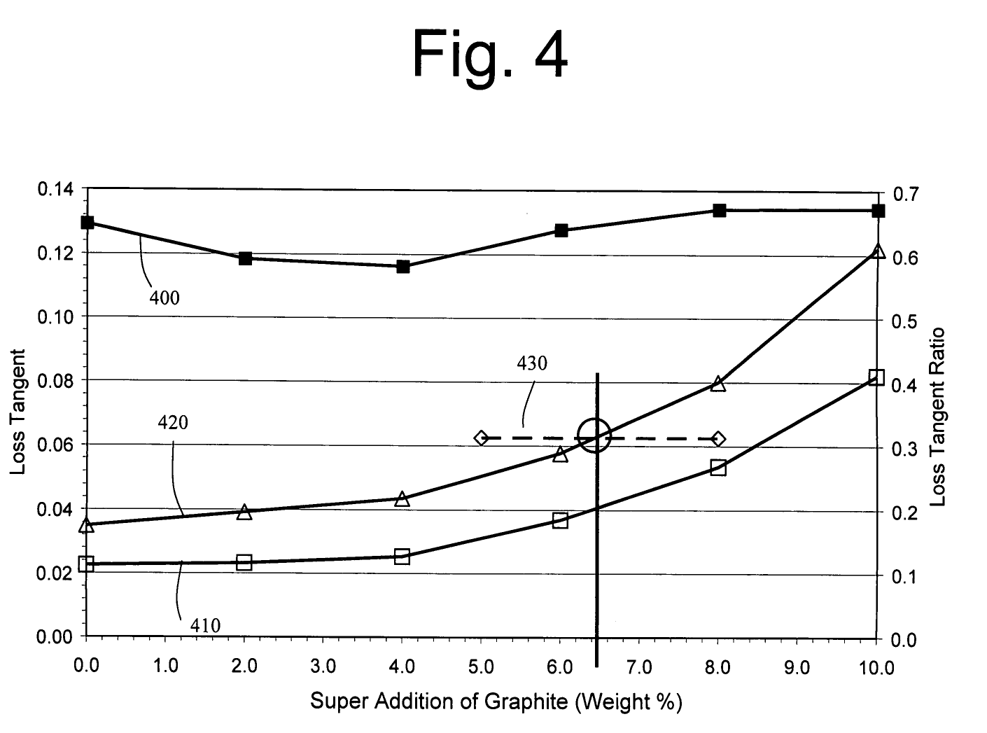

FIG. 4 shows the “loss tangent ratio” (tan δ)(ref. 7), which is the ratio of the effective loss factor (ε″) to that of the dielectric constant (ε′), given by equation (1):

$$tan δ = \frac{{ɛ}^{″}}{{ɛ}^{′}} \qquad ( 1 )$$

of the dielectric properties dry to the dielectric properties wet, given by equation (2):

$$\frac{tan {δ}_{dry}}{tan {δ}_{wet}} \qquad ( 2 )$$

and can be, for example, less than about 0.61, and less than about 0.31, to prevent burning or overheating the log based on cordierite's dryability. FIG. 4 shows the loss tangent wet (400), the loss tangent dry (410), the loss tangent ratio (dry:wet) (420), and a comparative cordierite loss tangent ratio (430) with respect to the superaddition of graphite pore former. Thus, the effective dielectric properties of the composite and the open frontal area can be significant factors in selecting an appropriate radiation penetration depth or half power depth at relevant frequencies. The attenuation produced by a dielectric is frequently expressed as the attenuation distance, α⁻¹, through which the field strength decays to 1/e=0.368 of its original value, according to equation (3):

$${a}^{- 1} = {\frac{{λ}_{0}}{2 π} [ \frac{2}{{ɛ}^{1} ( \sqrt{1 + {tan}^{2} δ - 1} )} ]}^{1 / 2} ( meters ) \qquad ( 3 )$$

This is used to calculate half power depth (D_{½P}) which is a measure of the where the field strength decays to one-half (½) its initial value, according to equation (4):

$${D}_{1 / 2 P} = ( \frac{ln ( 2 )}{2} ) \cdot ( {a}^{- 1} \cdot 100 ) ( cm ) \qquad ( 4 )$$

The extrudate log should be sufficiently electrically transparent upon drying to prevent overheating of the edges and still effectively penetrate the core to vaporize any water within the matrix and completely dry the log's interior.

### Example 4

Drying Scaleup Example 3 was repeated on a larger scale twin screw extruder and associated drying system. AT batch mixtures were formulated with three different pore former ratios to assess their dry-ability:

1) a comparative higher graphite to starch weight ratio (5:4);

2) an intermediate graphite to starch weight ratio (1:1); and

3) a lower graphite to starch ratio (3:5).

The binder used for the higher graphite to starch ratio was an F-type. The binder used for the intermediate and lower graphite to starch ratios was the harder-to-dry K-type HPMC#1 which was used to achieve the higher extrusion feed rates and reflected a challenging condition for dry-ability. The drying results demonstrated significant improvements even for the harder-to-dry compositions.

The honeycomb wares were extruded and dried in a microwave (MW) drying unit followed by a radio frequency (RF) drying unit. MW applicators apply MW radiation corresponding to electromagnetic radiation in the frequency range of 900 to 2,500 MHz. RF applicators apply RF radiation corresponding to electromagnetic radiation in the frequency range of 20 to 40 MHz. Both MW and RF radiation is absorbed by the green ware. The liquid vehicle, such as water, can thus be driven off by the radiation, leaving a dry (or drier) piece of green ware.

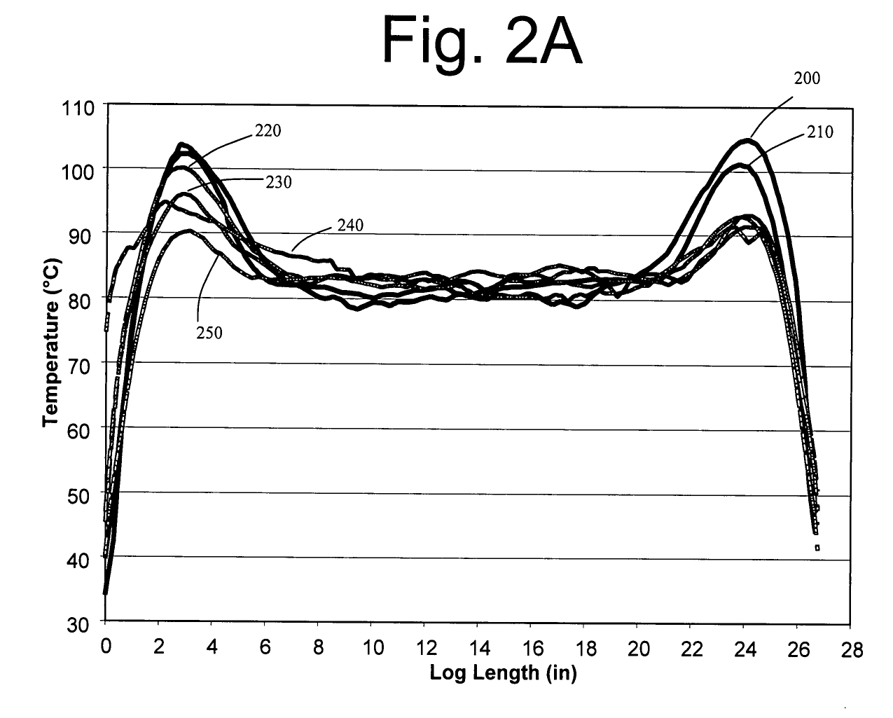

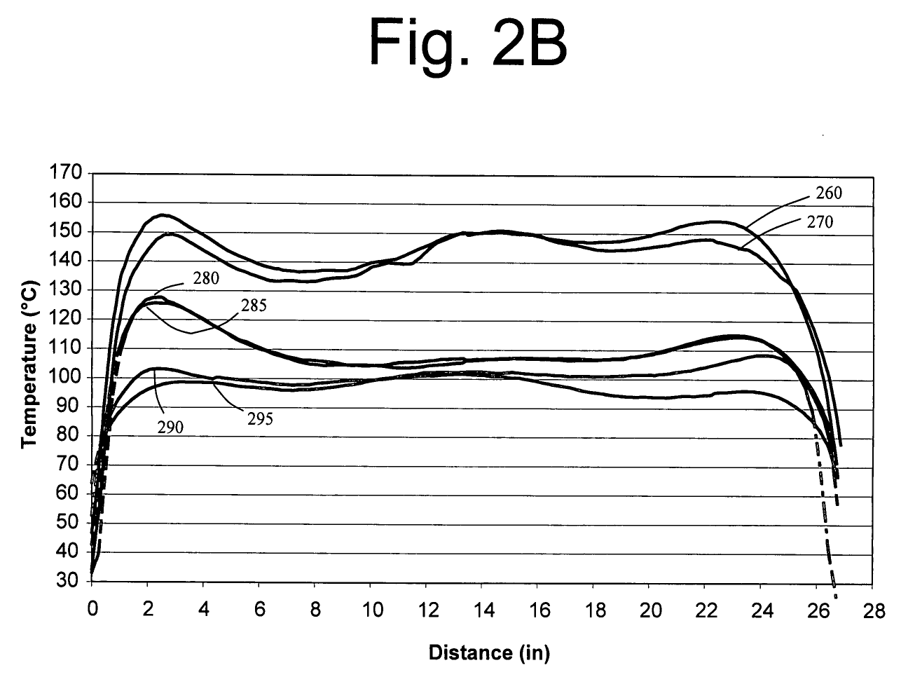

Forward Looking Infrared (FLIR) images (not included) were obtained for the representative log compositions exiting each drying unit and are summarized in Table 4. The composite or overlay temperature profiles across the log for MW drying only are shown in FIG. 2A, where the higher graphite to starch ratio samples (200, 210) had the highest temperature profile. The intermediate ratio samples (220, 230) and the lower ratio samples (240, 250) had significantly lower profiles. The composite or overlay temperature profiles across the log for MW drying followed by RF drying are shown in FIG. 2B, where a similar trend was observed for higher ratio (260, 270) samples and the intermediate (280, 285) and low ratio (290, 295) samples. The results show that the C1 control (C1) samples had higher and less desirable temperature profiles in both MW only (such as the hotter log ends in FIG. 2A) and with combined MW and RF drying (such as the overall hotter log profiles shown in FIG. 2B). Representative logs having the indicated compositions were split lengthwise upon exiting the dryer and thermal images were obtained across the face of each half of the split log and plotted as A and B pairs. The batch compositions of the disclosure (C3 and C5) had significantly lower and more desirable temperature profiles in MW only and with combined MW and RF drying. The measured temperature differentials (ΔT) for the logs are based on maximum (typically the log-end) to minimum (typically within the log-length) or maximum ΔT across the log. Lower ΔT is desirable and indicates improved dielectric properties and greater thermal uniformity.

Extruded wares of the disclosure had greater thermal uniformity and lower overall temperature profiles compared to extruded wares having higher graphite to starch ratios. The extruded wares of the disclosure could be dried at lower temperature, or alternatively or additionally, dried at higher throughput rates, for example, more logs per hour or more pounds per hour.

TABLE 4
ΔT drying dependence on Graphite to Starch Ratio and HPMC type

| | MW | | Overall Maximum |
|---|---|---|---|
| Pore former combination | Drying | RF Drying | Internal Temp - |
| (w:w) and binder | ΔT (° C.) | ΔT (° C.) | RF Drying (° C.) |
| C1 (Control) | 20 | 20 | 155 |
| Graphite:Starch = 5:4, | | | |
| F-type Methocel | | | |
| C3 | 16 | 20 | 125 |
| Graphite:Starch = 1:1, | | | |
| K-type Methocel | | | |
| C5 | 10 | 10 | 105 |
| Graphite:Starch = 3:5, | | | |
| K-type Methocel | | | |

The comparative control having a higher graphite ratio, two pore former formulation, is disclosed in the abovementioned copending U.S. Provisional Application No. 61/004996.

In embodiments, an exemplary pore former combination that maintains the properties of the extrudate and the subsequently fired article, and enables increased feed rates in both extrusion and drying can be, for example, a pore former combination having a weight percentage of about 6 to about 8 wt % graphite to about 8 to about 10 wt % starch based a super-addition to the inorganic components of the batch mixture prior to extrusion, or a graphite:starch weight ratio (w:w) of about 3:5 to about 1:1.

The disclosure has been described with reference to various specific embodiments and techniques. However, many variations and modifications are possible while remaining within the spirit and scope of the disclosure.

### REFERENCES

1. Methocel Cellulose Ethers Technical Handbook, Dow Chemical Co.
2. Sarkar, N., “Thermal gelation properties of methyl and hydroxypropyl methylcellulose,” J. Appl. Polym. Sci., 24, 1073-1087, (1979).
3. Sarkar, N., et al., “Methylcellulose Polymers as Multifunctional Processing Aids in Ceramics,” Ceramic Bulletin, 62, 1280, (1983).
4. Li, L et al., Langmuir, 18, 7291-7298 (2002).
5. Schuetz, J. E., “Methylcellulose Polymers as Binders for Extrusion of Ceramics,” Ceramic Bulletin, 65, 1556, (1986).
6. R. M. Hutcheon, et al., “A System for Rapid Measurements of RF and Microwave Properties Up To 1400° C.,” Journal of Microwave Power & Electromagnetic Energy, 27, (2), 87 (1992).
7. A. C. Metaxes, et al., in Industrial Microwave Heating, 26-82, Peter Peregrinus Ltd., London, England, 1983.

What is claimed is:

1. A ceramic precursor batch composition, comprising:
inorganic ceramic-forming ingredients;
a pore former consisting essentially of a mixture of a graphite and a starch, the mixture having a graphite to the starch weight ratio of from about 1:1 to about 3:5;
an organic binder consisting essentially of a hydroxypropyl methyl cellulose having hydroxypropyl substitution of from about 8 to about 15 wt % and methoxyl substitution of from about 20 to about 26 wt % based on the total weight of the hydroxypropyl methyl cellulose;
a fatty acid oil; and
a liquid vehicle.

2. The composition of claim 1 wherein
the inorganic ceramic-forming ingredients comprise from about 35 to about 75% by weight of the total batch material;
the pore former consists essentially of from about 13 to about 20% by weight of the inorganic batch material, by super-addition;
the hydroxypropyl methyl cellulose consists essentially of from about 3 to about 5% by weight of the combined inorganic and pore former batch materials, by super-addition;
the fatty acid oil comprises from about 0.2 to about 2% by weight of the combined inorganic and pore former batch material, by super-addition; and
the liquid vehicle to balance, based on the total weight of the batch mixture prior to extrusion.

3. The composition of claim 1 wherein the pore former consists essentially of from about 5 to about 8 wt % graphite and from about 8 to about 10 wt % starch based on the weight of the inorganic ingredients of the batch mixture, by super-addition, prior to extrusion.

4. The composition of claim 1 wherein the starch comprises at least one starch from: corn, barley, bean, potato, rice, tapioca, pea, sago palm, wheat, canna, or a combination thereof.

5. The composition of claim 1 wherein the starch is potato starch.

6. The composition of claim 1 wherein the composition provides an increased extruder feed rate of from about 25% to about 40% and an increased dryer feed rate of from about 25% to about 40% compared to a batch consisting of a graphite to starch ratio of 5:4 or greater and a hydroxypropyl methyl cellulose binder with hydroxypropyl substitution of about 4 to about 7.5% and methoxyl substitution of about 27 to about 30% based on the total weight of the hydroxypropyl methyl cellulose

7. The composition of claim 1 wherein the batch has a gelation onset temperature difference (Δ Tₒₙₛₑₜ) of from about 5° C. to about 15° C., at a constant material stiffness compared to a batch having a hydroxypropyl methyl cellulose binder with hydroxypropyl substitution of about 4 to about 7.5%.

8. The composition of claim 1 further comprising cordierite, mullite, clay, talc, zircon, zirconia, spinel, aluminas and their precursors, silicas and their precursors, silicates, aluminates, lithium aluminosilicates, alumina silica, feldspar, titania, fused silica, nitrides, carbides, borides, silicon carbide, silicon nitride, soda lime, aluminosilicate, borosilicate, soda barium borosilicate, or mixtures of thereof.

9. A ceramic forming green body, comprising:
a homogeneous mixture of inorganic ceramic-forming materials in an amount of from about 40 to about 70 wt % of the body;
a pore former consisting essentially of a mixture of a graphite and a starch in an amount of from about 13 to about 20 wt % as a super-addition to the body in a graphite to starch weight ratio of from about 1:1 to about 3:5; and
an organic binder in an amount of from about 3 to about 5 wt % as super-addition to the combined weight of the inorganic ceramic-forming materials and the pore former, the binder consisting essentially of a hydroxypropyl methyl cellulose having a hydroxypropyl substitution of from about 8 to about 15 wt %.

10. A method for enhancing feed rates in extruding and drying in the manufacture of a ceramic precursor green body, the method comprising:
mixing inorganic ceramic-forming ingredients with a pore former consisting essentially of graphite and starch, the weight ratio of graphite to starch is from about 1:1 to about 3:5, to form a batch;
adding an organic binder consisting essentially of a hydroxypropyl methyl cellulose having a hydroxypropyl substitution of from about 8 to about 15 wt % and a liquid vehicle to the batch and further mixing to form a plasticized mixture; and
extruding and drying the plasticized mixture to form the green body.

11. The method of claim 10 wherein the green body is a log having a maximum temperature difference ΔT across the log length of less than about 20° C. during drying.

12. The method of claim 10 wherein extruding is accomplished at an increased feed rate of from about 25 to about 40% compared to a batch having a pore former consisting essentially of a graphite to starch ratio of 5:4 and a hydroxypropyl methyl cellulose binder with hydroxypropyl substitution of about 4 to about 7.5% and methoxyl substitution of about 27 to about 30 wt % based on the total weight of the hydroxypropyl methyl cellulose.

13. The method of claim 10 wherein drying is accomplished at an increased feed rate of from about 25 to about 40% compared to a batch having a pore former consisting essentially of a graphite to starch ratio of 5:4 and a hydroxypropyl methyl cellulose binder with hydroxypropyl substitution of about 4 to about 7.5% and methoxyl substitution of about 27 to about 30 wt % based on the total weight of the hydroxypropyl methyl cellulose.

14. The method of claim 10 wherein ceramic-forming ingredients comprise sources of alumina, titania, silica, or mixtures thereof.

15. The method of claim 10 further comprising firing the green body to produce a predominant ceramic phase.

16. The method of claim 15 wherein the predominant ceramic phase is aluminum titanate.

17. The method of claim 16 wherein drying the green body is accomplished with microwave radiation, radio frequency radiation, or a combination thereof.

18. The method of claim 16 wherein drying provides an extrudate log having a temperature profile having a temperature difference ΔT across the log's length of less than about 20° C.

19. A method for controlling the gelation onset temperature during extrusion of a honeycomb green body batch, the method comprising:
mixing inorganic ceramic-forming ingredients with a pore former consisting essentially of graphite and starch, the weight ratio of graphite to starch is from about 1:1 to about 3:5, to form a batch;
adding an organic binder consisting essentially of a hydroxypropyl methyl cellulose having a hydroxypropyl substitution of from about 8 to about 15 wt % and a liquid vehicle to the batch and further mixing to form a plasticized mixture; and
extruding the plasticized mixture to form the green body, the extruded mixture having a gelation onset temperature difference (Δ Tₒₙₛₑₜ) of from about 5° C. to about 15° C., at a constant material stiffness or viscosity compared to a batch having a pore former consisting essentially of a graphite to starch ratio of 5:4 and a hydroxypropyl methyl cellulose binder with hydroxypropyl substitution of about 4 to about 7.5% and methoxyl substitution of about 27 to about 30 wt % based on the total weight of the hydroxypropyl methyl cellulose.
